(19) United States
(12) Patent Application Publication
(10) Pub. No.: US 2010/0278005 A1
(43) Pub. Date: Nov. 4, 2010

(54) Magnetic bubble mixer forming plate assembly

(76) Inventors: Richard J. Koopmans, Bellevue, WA (US); Kristinn G. Drewry, Bellevue, WA (US)

Correspondence Address: Anthony Claiborne, 849 136th Ave. N.E., Bellevue, WA, 98005, US

(21) Appl. No.: 12/387,365

(22) Filed: May 1, 2009

(51) Int. Cl. B01F 13/02

(52) U.S. Cl. 366/101

(57) ABSTRACT

An improved bubble forming plate for a mixer employing large bubbles to mix liquids in a tank, comprising a gas injector, a bubble-forming undersurface and at least one permanent magnet affixed to the plate, the magnet providing sufficient magnetic force to retain the plate against the inner surface of the tank.

### BACKGROUND OF THE INVENTION

1. Field of the Invention

This invention relates to methods for mixing liquids by the injection of gas to form large mixing bubbles. More specifically, this invention relates to forming plates used to form such large mixing bubbles within a tank, such plates fashioned to employ magnetism to adhere to the tank.

2. Description of the Related Art

Liquids and liquid suspensions may be mixed by using compressed gas to generate large mixing bubbles within the liquid. The large mixing bubbles generate currents as they rise through the liquid. As described in U.S. Pat. Nos. 7,282,141, 7,373,675 and 7,524,419 for waste liquid mixing and in U.S. patent application Ser. No. 12/290,661, filed Oct. 31, 2008 and application Ser. No. 12/381,942, filed Mar. 18, 2009 for drinking water supplies, sufficiently large bubbles (6 inches or greater in diameter) can generate sufficiently strong currents to cause significant mixing of different portions of the liquid.

In order to form such large bubbles, these mixers employ bubble-forming plates. As explained in greater detail below, such a plate operates by accumulating pressurized gas on its lower surface, gas accumulation continuing until the quantity of gas held under the plate has sufficient size to rise around the edges of the plate, forming a large bubble.

For producing adequate mixing currents, a sufficient number of bubble-forming plates must be located strategically within the tank. To resist displacement by the buoyancy provided by accumulating gas, plates must be appropriately affixed within the tank. Plates may be mechanically affixed in tanks by welding or bolting plate assemblies to the tank walls or floors. Mechanical fixation, however, is labor intensive and impractical or impossible when adding mixers to a filled or partially filled tank, as in the case of retrofitting a tank already in use.

### BRIEF SUMMARY OF THE INVENTION

The present invention is an improved bubble forming plate for a mixer employing large bubbles to mix liquids in a tank. The plate assembly comprises a gas injector, a bubble-forming undersurface and a strong permanent magnetic means for adhering the plate to the wall or floor of the tank.

### BRIEF DESCRIPTION OF THE DRAWINGS

The foregoing objects, as well as further objects, advantages, features and characteristics of the present invention, in addition to methods of operation, function of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1 is a perspective view of a bubble forming plate;

FIG. 2 is a diagram illustrating mixing of liquid in a tank by turbulence caused by rising bubbles formed by the present invention;

FIG. 3 is a diagrammatic overhead view of an arrangement of plates in a rectangular tank;

FIG. 4 is a diagrammatic overhead view of an alternative arrangement of plates in a rectangular tank;

FIG. 5 is a diagram illustrating a magnetic plate assembly according to an embodiment of the present invention; and

FIG. 6 is a diagram illustrating a magnetic plate assembly according to an alternative embodiment of the present invention.

### DETAILED DESCRIPTION OF THE INVENTION

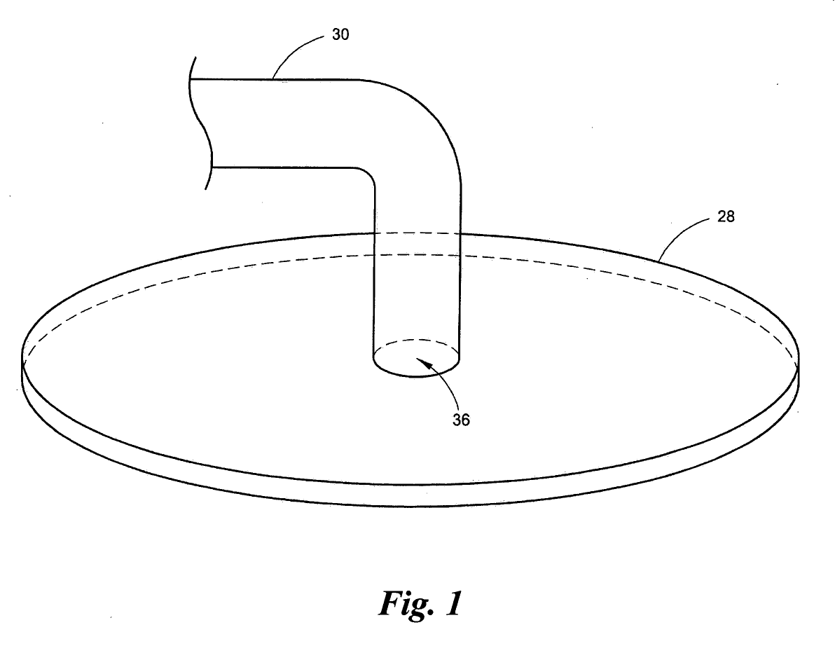

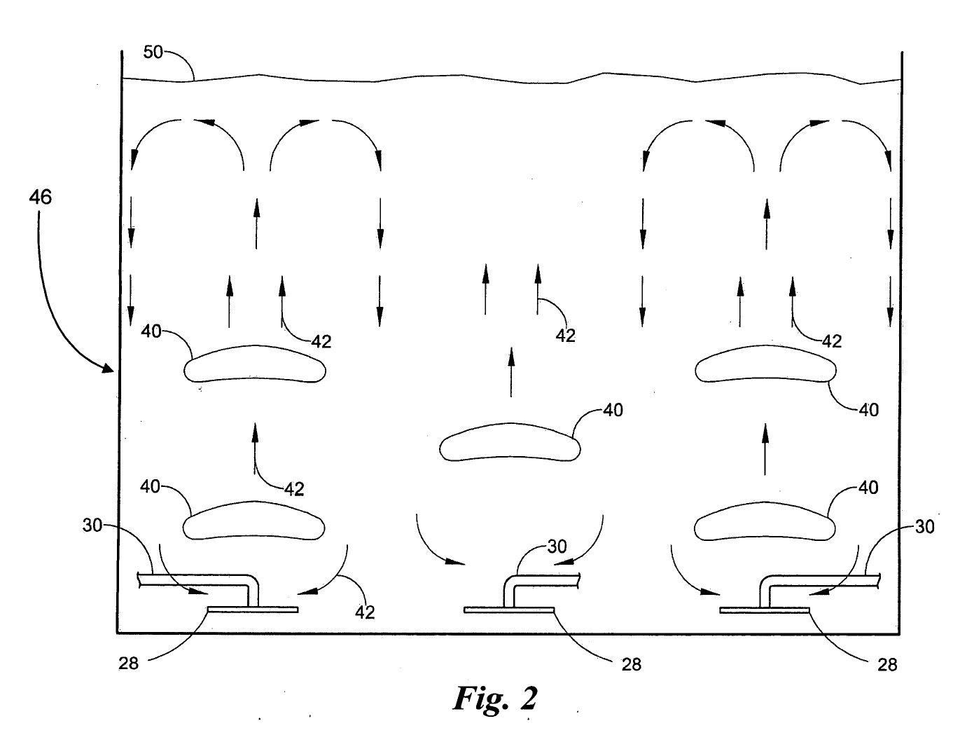

FIG. 1 illustrates a bubble forming plate assembly 14. When assembly 14 is in place in the tank, in operation and submerged in liquid, compressed gas is provided from supply line 30 to pass through injector 36, the gas accumulating on the underside 32 of plate 28. The forming plate 28 prevents the gas from rising toward the surface of the water until more gas is accumulated through injector 36 from supply line 30 than the forming plate 28 can hold, at which time most of the gas escapes from the underside 32 of forming plate 28, forming a large mixing bubble. The large mixing bubble then rises toward the surface of the water, resulting in currents in the liquid causing mixing as described below in relation to FIG. 2.

FIG. 2 illustrates the mixing of liquid 50 in a tank 46 caused by the large bubbles generated by a number of plate assemblies. Plates 28 receive compressed gas from supply lines 30, the gas accumulating on the undersides of plates 28 and forming large mixing bubbles 40 as described above in relation to FIG. 1. The mixing bubbles 40 generate the mixing currents indicated by the arrows 42 (28 arrows shown but only 5 labeled with the reference number 42 for clarity) that mix liquid 50. The strength of the mixing currents 42 depends on the speed at which each mixing bubble 40 travels through the water and the size of each bubble 40.

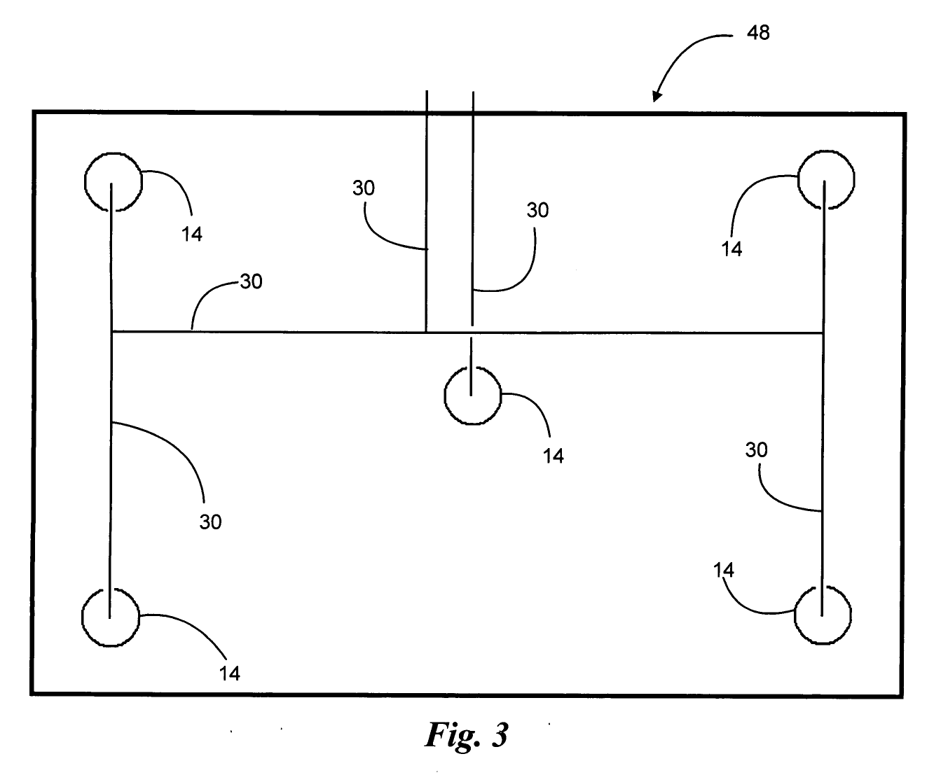

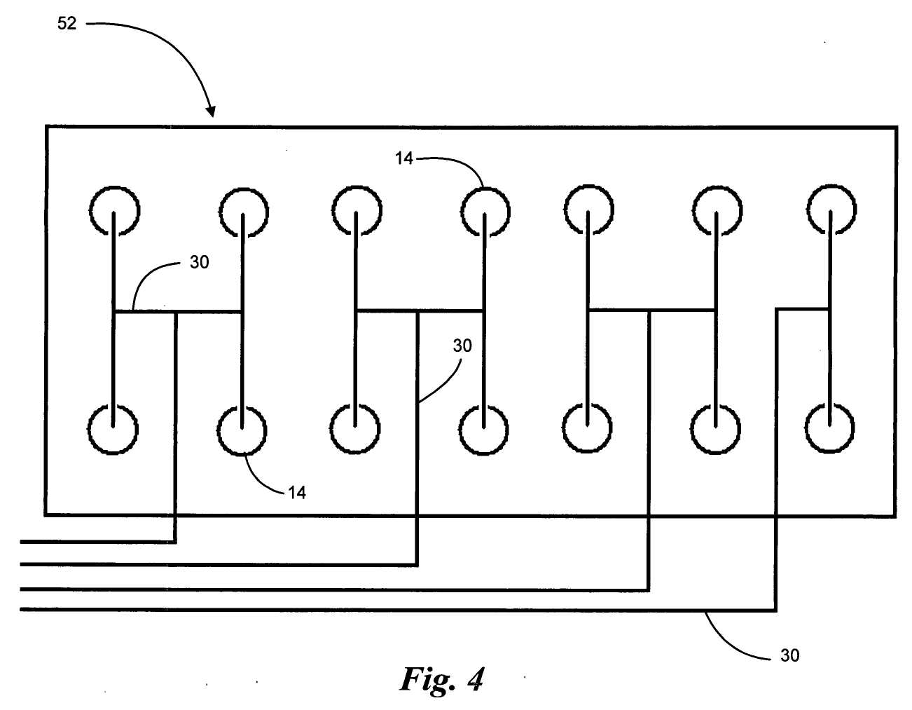

For adequate mixing of the liquid in a tank, a sufficient number of bubble forming plates must be distributed and affixed throughout the tank to produce enough current from the large bubbles for the mixing process throughout the tank. The number of plates deployed and their distribution configuration will depend upon the geometry of the tank, the nature of the liquid, the size of the plates and the degree and uniformity of mixing desired. FIG. 3 is an overhead diagram of one such configuration. In this configuration, five plate assemblies 14 supplied by gas supply lines 30 are affixed to the bottom of rectangular tank 48 in the configuration shown. FIG. 4 illustrates an alternative configuration of plate assemblies 14 for a tank 52 of different geometry. As will be clear to those of skill in the art, if the plate assemblies move significantly out of configuration, mixing may not occur as desired throughout tank. Accordingly, it is important that plate assemblies be affixed within the tank in the desired configuration.

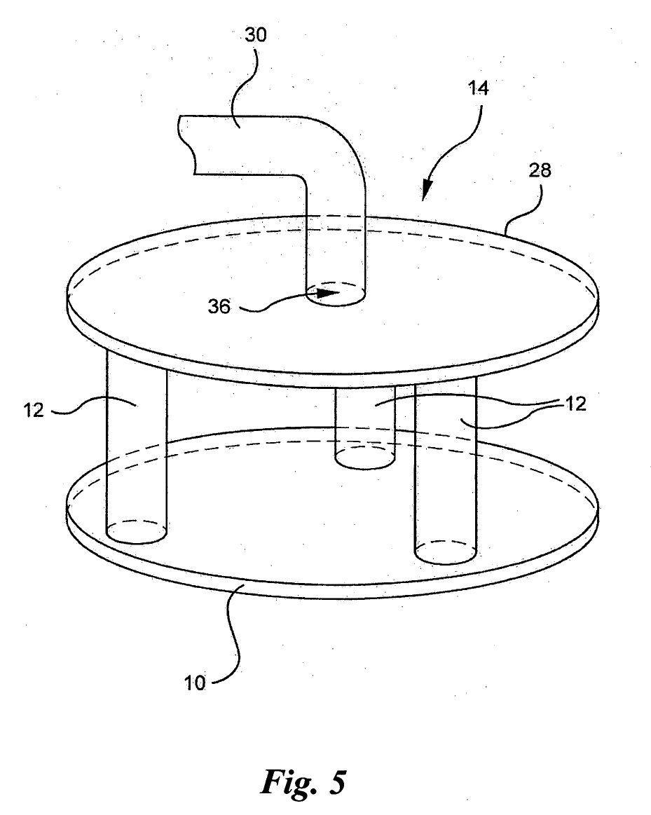

FIG. 5 illustrates one embodiment of the present invention in which plate assembly 14 comprises plate 28 connected to permanent magnet disc 10. Spacers 12 separate plate 28 from disc 10 to provide an area in which gas can accumulate for bubble formation on the underside of plate 28 as discussed above in relation to FIG. 1.

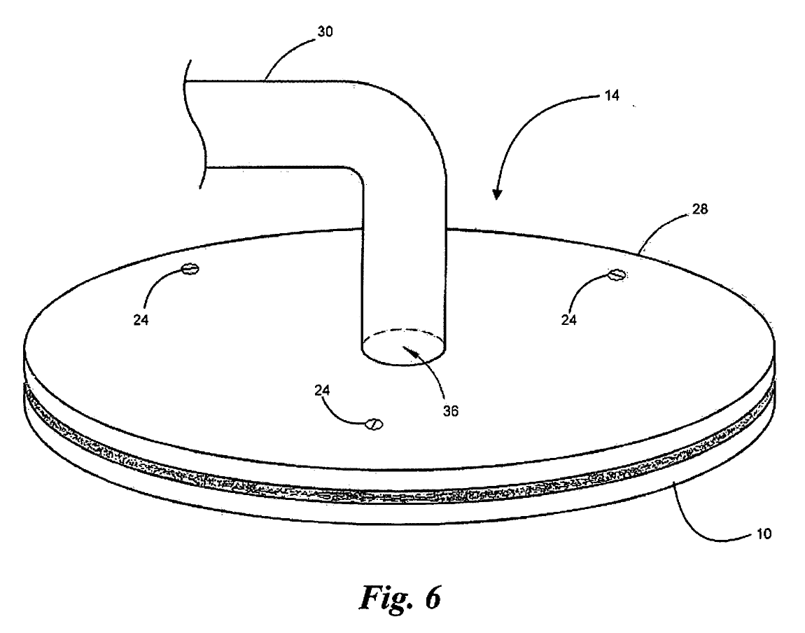

FIG. 6 illustrates another embodiment of the present invention, in which plate assembly 14 comprises screws 24 connecting plate 28 to permanent magnet disc 10 with a small offset between plate 28 and disc 10 to allow for bubble formation. In various embodiments, as will be understood by those in the art, the minimum required distance between plate 28 and magnetic disc 10 for formation of large mixing bubbles may vary depending upon the geometry of plate assembly 14 and nature of the liquid (for example, its viscosity and surface tension). Accordingly, depending upon the embodiment and application, the distance between plate 28 and disc 10 may be as small as ¼ inch or less to as large as 10 inches or more.

Bubble forming plate assemblies may be positioned and affixed in ferromagnetic tanks simply by lowering the assembly from an access point in the upper part of the tank to a strategic position in the bottom of the tank, where the magnetized portion of the plate assembly will magnetically adhere to the floor of the tank. As will be understood by those in the art, the magnetic adhesion utility of the plate assembly enables retrofitting of a tank with bubble mixers without requiring the tank to be taken offline.

As will be further appreciated by those in the art, the dimensions and configuration of the magnetic elements for the plate assembly may vary considerably while remaining consistent with the present teachings. Although the magnets 10 as depicted in FIGS. 5 and 6 are disc-shaped and roughly the same diameter as the forming plates 28, it will be understood that the present invention encompasses any embodiment comprising a permanent magnetic element capable of retaining the assembly against buoyancy in bubble formation, the element affixed to the plate in such a manner as to allow bubble formation under the plate when the magnet adheres to the tank. As will be yet further appreciated by those in the art, rather than a single magnetic element, a plurality of magnets may be affixed to a single bubble forming plate to provide the magnetic force needed to adhere the plate assembly to the tank. Magnets in keeping with the present invention are available from a wide variety of sources, including Monroe Engineering of Auburn Hills, Mich.

Although the detailed descriptions above contain many specifics, these should not be construed as limiting the scope of the invention but as merely providing illustrations of some of the presently preferred embodiments of this invention. Various other embodiments and ramifications are possible within its scope, a number of which are discussed in general terms above. While the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention.

I claim:

1. An apparatus for mixing liquid in a ferromagnetic storage tank, comprising a supply of compressed gas and at least one plate assembly, the plate assembly comprising:
a bubble forming plate;
an injector within the bubble forming plate for receiving compressed gas from the supply; and
a permanent magnetic element affixed to the bubble forming plate, the magnetic element possessing sufficient magnetic force to retain the plate assembly against the inner surface of the tank.

2. An apparatus for mixing liquid in a ferromagnetic tank according to claim 1, wherein the permanent magnetic element is a disc magnet.

3. An apparatus for mixing liquid in a ferromagnetic storage tank, comprising a supply of compressed gas and at least one plate assembly, the plate assembly comprising:
a bubble forming plate;
an injector within the bubble forming plate for receiving compressed gas from the supply; and
a plurality of permanent magnetic elements affixed to the bubble forming plate, the magnetic elements together possessing sufficient magnetic force to retain the plate assembly against the inner surface of the tank.
